(19) United States
(12) Patent Application Publication
(10) Pub. No.: US 2010/0021681 A1
(43) Pub. Date: Jan. 28, 2010

(54) Universal Sledge and Slide

(76) Inventor: Robert James Scarborough, Lincoln (GB)

Correspondence Address: Robert James Scarborough, Number 6, Albion Street, Grantham, Lincoln, NG31 8BG, GB

(21) Appl. No.: 12/503,143

(22) Filed: Jul. 15, 2009

(30) Foreign Application Priority Data
Jul. 23, 2008 (GB) 0813449.6
Sep. 25, 2008 (GB) 0817550.7
Jun. 4, 2009 (GB) 0909619.9

(51) Int. Cl. B32B 3/06; B32B 1/04

(52) U.S. Cl. 428/99; 428/119

(57) ABSTRACT

A portable Slide and/or Sledge; comprising one sheet or a plurality of overlapped sheets, which can be arranged and anchored to an underlying, supporting substrate thereby performing the role of a Slide; including anchorage means suitable for loose substrate such as sand, wherein at least one curved, cylindrical or tear drop configured portion of a sheet or plurality of sheets, is buried/filled with substrate, forming anchorage of the Slide. Said curved, cylindrical or tear drop configured portion of a sheet may also act as a cushioned area at one or both ends of a sheet performing the roll of a Sledge. The present invention is best illustrated by FIG. 21.

This application claims the benefit of GB Application Nos. 0909619.9, filing date 4 Jun. 2009, also; 0817550.7; filing date 25 Sep. 2008, and 0813449.6 filing date 23 Jul. 2008 which are hereby incorporated by reference in their entirety.

### DESCRIPTION

The present invention involves a lightweight and easily portable sheet, or a plurality of substantially oblong sheets which may be lapped and adjoined. When said sheet/s are arranged and fastened in specific configurations; either permanently, or temporarily (for example see FIGS. 2, 3, 7, 12, and 22); and/or are lapped with similar adjacent sheets; a set of requirements are met whereby said sheet/s is/are able to successfully perform the role of a Portable amusement Slide; including anchorage means to various penetrable underlying supporting surfaces (for example Sand). In order to allow anchorage of said Slide apparatus in loose sandy substrate, snow or similar, a range, and combination of possibilities may be considered: It may be possible to use modified pegs 17, of hollow, tapered, tubular construction (FIGS. 16/17), which will provide more resistance (than parallel walled hollow pegs) to the sand or substrate into which they are inserted, as well as allowing a plurality of tubular pegs to be stacked one inside another for carriage. Another example of possible anchorage means particularly suited to anchoring a Slide on sand, snow or similar, is to use at least one end of a single sheet, or at least one end of any of a plurality of adjoined sheets which form an elongated Slide as an anchoring means when held in a desired configuration. A first end of a sheet can be curved underneath an adjacent portion of the same sheet, and using a temporary or permanent means, held in this configuration, thereby forming a tubular enclosure which may be tear drop shaped 4, cylindrical 6, or curved 8, (when viewed from a side elevation). All of these shapes are suitable for the purpose of anchorage or weighting of the sheet when the inside of the configured area (4,6 or 8) is filled with a substrate, for example sand. For multi location use of a sheet or sheets as a Slide, including for example grass/soil 25 (FIG. 23); or other firm substrate, then a simple method of pegging similar to tent pegs would be adequate to anchor the Slide, although the tops of the pegs may need to be rounded and smooth 23 (FIG. 23) to avoid being problematic or dangerous to users.

An advantage of a Slide herein described, wherein a plurality of adjoined sheets are supplied, is that each sheet can, if required, be pegged or otherwise anchored at a point where the pegged sheet is overlapped by an adjacent sheet, thus protection to the user is offered by the overlap. For example, the final (bottom) sheet of a plurality of sheets, forming an elongated slide of a chosen length, may be anchored underneath the overlap of the sheet above, and so on up the Slide, the top sheet being the only sheet to have pegs (or other anchorage means) which are not covered by an adjacent sheet. In an example where pegs are used at the top of a Slide, these pegs could feature vertical extensions upward, providing launch handles/grips at the top of the Slide. All pegs would of course pass through holes 15 provided in the sheets at required points, or at constricted areas of a sheet.

In addition to the role of a Slide, the apparatus of the Slide herein described may also be able to perform further roles of a number of desired objects, for example those of a Sledge, a simple Mould/Sand play accessory, or an elongate track, (consisting of one or more lapped sheets). An elongate track surface; may be potentially useful as an elongated Slide as already described, but may also serve other roles, for example as a Toy Track/Road system for toy vehicles (cars, lorries, trains, boats etc.), suited to a Sand Play environment or elsewhere, potential use defined primarily by sheet dimensions.

In order to fully understand the scope of the present invention as outlined above, it is necessary to consider the properties of the preferred sheet/s chosen for the purposes of the invention; particularly in terms of the formation of configurations (e.g. 4,6 and 7), how to take advantage of the natural properties of said sheet/s, and how to enhance those properties by means of additionally created characteristics, such that the sum of these properties/characteristics result in combinations of desired properties that help said sheet/s fulfil said roles of desired objects such as a Slide, a Sledge, a Sand/Snow mould, or an elongated toy track;

Natural Properties of a Sheet:

Said sheet/s are preferably to be composed of a stiff surfaced but flexible material for example plastics materials such as high density polyethylene (HDPE).

With regard to natural properties of a sheet, one preference is that a degree of captured tension and strength is able to be created as a result of arranging said sheet/s in certain configurations when said sheet/s are of certain length and widths relative to the type and thickness of the material of composition of the sheet. This “tension” characteristic can lead; for example, to self supporting areas of sheet/s structure when held in one of said configurations as part of a proposed role (for example 4,6,7 of FIGS. 2, 3 and 7). In the example of a sheet/s composed of a Plastics material, such as HDPE, the preference for such a “tension” characteristic is met, this is partly due to the molecular structure of said Plastics material, i.e. the fact that a manufactured flat sheet composed of such a Plastics material; has a degree of flexibility and a “memory,” wherein said plastics sheet/s will naturally try to resume a former configuration, (which may have initially been formed as a result of a process involving heat.) This “memory”, leads to a tension in the sheet when held in certain configurations (for example 4 and 6), unless the sheet is reheated, or sufficient force or pressure applied while cold to overcome this tension characteristic (for example a crease being formed). Said “memory”, flexibility and tension characteristics are beneficial to the present invention as will later be further described.

Chosen Properties and Additionally Created Characteristics of a Sheet/s:

The thickness of a preferred sheet/s chosen for the present invention is important, said sheet preferably being lightweight and flexible enough to be able to be retained and fastened in various configurations but also strong enough to cope with the forces applied during performance of said roles as desired objects. Also, sheet/s preferably are able to be multi-layered or overlapped without excessive ridges being formed at the point of overlap; So for example, a 1 mm or 2 mm thickness would be fine, but, a 6 mm sheet thickness would be much too thick.

In the present invention a number of possible roles are suggested for the sheets described; an approximate range of suitable thickness of a suitable plastics material such as HDPE; can be summarised as follows:

A sheet performing the role of a Sledge for human (adult or children) recreational use is preferably manufactured with a sheet thickness of between 1 mm and 3 mm.

A sheet performing the role of a Slide/elongate Slide; supportable by an underlying substrate with at least one duly configured end for anchorage in loose substrate; is preferably manufactured with a sheet thickness of between 1 mm and 2 mm.

A sheet performing the role of a Mould, is preferably manufactured with a sheet thickness between 0.5 mm and 1.5 mm.

A sheet performing the role of a toy track wherein wheeled vehicular toys are pushed, is preferably manufactured with a sheet thickness between 0.5 mm and 1.5 mm.

A sheet performing any of the above roles, including a “tab and locating device” fastening means, is preferably manufactured with a sheet thickness of between 0.5 mm-3 mm.

Thus in general terms a range of thickness of a plastics material, suitable for the best performance of the roles suggested herein would be between 0.5-3 mm, however dimensions may vary beyond these limits in certain circumstances, for example, if other materials are considered in forming the apparatus.

A further preferred “chosen” property of said sheet/s is a consistent profile or flatness, which allows all, or portions of said sheet/s to be easily flexible in both directions, for example longitudinally into tear drop or cylindrical shapes, as anchors, moulds or for rolling up easily. A flexibility across a sheet, is useful for example to help with engagement or release of possible side edge fastening means, as will be further described later.

Preferred Features of the Apparatus

Preferred features of the present invention include that said sheet/s include means with which at least one end of a sheet is retained in said chosen configurations (curved, teardrop or cylindrical), said means may be permanent or temporary, or a sheet may comprise for example, a permanently formed configuration and also a temporary means of configuring and reconfiguring a sheet/s; (comprising for example, co-operating fastening means 10 and 11 at chosen positions on said Sheet/s,) Wherein said co-operating fastening means may also be capable of being used to join one of said sheets to a similar sheet/s, creating an elongate sheet (for example FIG. 25), each sheet of which is also able to be arranged in said chosen configurations (for example tear drop 4 and cylindrical 6 or 7), and in addition, said sheet/s can also be arranged in a track formation, with adjacent units arranged with their surface either straight in direction, or with bends or curves, in various directions, sheets should also preferably be arrangeable in multiple layers if desired (for example FIGS. 14, 26).

### STATEMENT OF INVENTION

A range of sheet/s of a material such as previously described, may lead to the provision of: A Slide comprising at least one substantially oblong sheet of flexible material, with means of anchorage to an underlying, supporting, penetrable surface, wherein a means of anchorage includes at least one end of said sheet arranged to form a curved, teardrop or cylindrically configured tubular enclosure, with said tubular portion arranged substantially perpendicular to the general longitudinal axis of the sheet such that said enclosure is incorporable with the underlying substrate to form anchorage of the Slide.

Also: A Sledge comprising a substantially oblong sheet of flexible material with means of cushioning over an underlying substrate, wherein a means of cushioning includes at least one end of said sheet, arranged to form a curved, teardrop or cylindrically configured tubular enclosure, with the tubular portion arranged substantially perpendicular to the general longitudinal axis of the sheet.

Said apparatus of the Slide/Sledge will be preferably produced in a variety of sizes to best suit the needs of proposed users of differing ages and sizes, possibly be variously re-configurable to suit a number of desired alternative roles and/or for storage/carriage purposes, and have other desirable variations or additions to a sheet as desired to suit additional embodiments of the invention. These will be further described herein.

From the above description, it is clear to see that the general range of suitable thickness of sheets of material suitable for the present invention is between 0.5 mm and 3 mm, however it should be noted that in a further possible variation, outside this general scope (FIG. 6), a sheet intended to perform the role of a Slide only, may comprise a single sheet, with anchorage means to a loose underlying substrate wherein the duly configured end or ends are formed and retained across the width of the Slide, using for example heat welding/heat forming or stitching 42. A Slide such as this could be produced; using for example a heavy duty polythene sheet of 1000 gauge thickness, which is strong enough to resist forces, when filled with substrate as an anchor, however the apparatus of a Slide such as this, would not in the present invention be easily inter connectible with other similar Slides to form an elongate Slide, nor be suitable for use as a Sledge or Mould or inter connectible track, nor indeed would such a sheet (1000 gauge) be easily made suitable for any role wherein a fastening means such as the “tabs and locating devices” described herein is required.

### PRIOR ART

In the prior art various lawn fun Slides already exist similar to the present invention, i.e. based on a flat sheet pegged to a surface, however, these mostly include a pegging system suited only to a compact soil/lawn setting, or may use alternative anchorage such as tubes full of water; requiring connection to nearby hose pipes (in the case of wet slides for example). Although such Slides are rollable and storable, they are seldom adaptable easily for use in a range of environments, nor, in the known prior art do they potentially fulfil several roles, nor offer much versatility in these roles, which would enable economic production of more robust and heavy duty versions due to the added values of the various uses. In my own prior art, GB 2435 223 a beach sand Slide is described, with anchorage consisting of down turned edges, however the down turned edges get in the way should you wish to use the Slide elsewhere e.g. a grass bank, or if a role as a Sledge or mould etc. is also proposed. similarly in GB 2441 911, the attached tubular anchorage pegs described, are cumbersome, would not be suitable for use on a grass bank, and would get in the way in that situation or if used as a Sledge etc.

Numerous moulds appear in prior art, but few, I believe are designed with further roles in mind, as in the present invention. Common problems with this prior art include fastening means encroaching too much on the surface of such sheets, which restrict the possibility of using said sheets in other roles, such as Sliding Sledging or as a Toy track; and indeed in prior art moulds, fastening means may restrict upward removal or movement of such moulds without unfastening, easily releasable fastening means being a useful attribute of the present invention. Also in the prior art fastening means are seldom integral to the sheet, thus additional problems wherein separate items may be easily lost, and smaller detachable items not suited to use by small children for safety reasons.

Sledges in the prior art mostly seem to focus on Snow, and often include complicated steering or strengthening features, such as ridges or crimped shaping, these ridges are in my opinion detrimental to the operation of such Sledges on other substrates such as Sand/grass or an underlying accelerator Slide, where a smoother flat bottom is beneficial, also, a more comfortable ride is possible on a Sledge of the present invention, due to the flexibility of the sheet, when travelling over contours, the cushioning effect of the configured end/s and the general absence of ridges etc. over which a rider may be expected to lay or otherwise position themselves.

Toy Tracks in the prior art, seem to fall into two main types, either 3D sectional track, joined by push fit, snap on, jigsaw type alignment or similar means, or flat 2D track permanently drawn onto a large sheet often with additional scenery etc. permanently graphically represented. It is the aim of the Toy Track of the present invention to provide a “middle ground” wherein despite actually being 3D, said track is very thin, for example 1 mm, such that multiple overlapping of several pieces of track when fastened together, allows elongation or adjustable branching of track, but does not create steps in the surface too difficult for certain toy vehicles to pass over reasonably smoothly. Said thin track is also flexible enough to be formed and fastened into self supporting curved configurations, serving for example as flyovers, bridges or hills, as will be later described in further detail.

There is, I believe a market for a low cost alternative to the prior art described, which makes it beneficial to find extended uses for the apparatus of the present invention, or ways of prolonging the usable season, as, in the example of a Slide or a Mould usable in varying locations, (at the beach or in the garden sandpit) whilst maintaining the utmost simplicity in terms of design weight, storage and carriage capabilities; such that a versatile and lightweight sheet or sheets is able to be temporarily re-configured such that said sheet/s may fulfil a number of roles desirable to a leisure user, and it is the object of the present invention to achieve this, thus creating positive advantages over existing Art.

### WITH REFERENCE TO THE DRAWINGS

FIG. 1 Plan view of an example of a 1-2 mm thickness first sheet, shown laid out flat as may be required for use as a Slide on a grass bank, also showing: holes 15, for anchorage pegs (if required) at the top of a Slide, tabs and examples of locating devices 11 into which tabs 10 can be located thereby providing fastening means for re configuration of said sheet, or attachment of adjacent sheets.

FIG. 2 Perspective view from the front/side and above. An example of a 1-2 mm thickness first sheet where only one sheet is provided, shown after the first end 20, of the sheet is downwardly curved and retained in a tear drop configuration using a tab 10 and locating device 11, system.

FIG. 3 Perspective view from the front/side and above. An example of a 1-2 mm thickness first sheet where only one sheet is provided, shown after the first end of a first sheet is downwardly curved and retained in a cylindrical configuration using a tab 10 and locating device 11, system.

FIG. 4 Plan View. An example of a 1-2 mm thickness; adjacent sheet of the second described embodiment, showing examples of fastening means for attachment to a first sheet (or other adjacent sheet), with letterbox system, and examples of possible means of secondary anchorage when required as part of an elongate Slide; including holes 15 for pegging to grass (if required), located on a narrowed portion (the narrowing of this portion 32, is essential in this example of a letterbox system of attaching sheets together), additional tabs and locating devices are shown prior to being configured (into a teardrop or cylinder) for secondary anchorage to sand or similar.

FIG. 5 Perspective view from the front/side and above, of an example of a 1-2 mm thickness; adjacent sheet of the second embodiment, similar to FIG. 4, but showing alternatively positioned locating devices wherein for example, a first sheet above would directly overlap and fasten to said adjacent sheet without the need for a letterbox and reverse lap flap arrangement. Means of secondary anchorage to Sand 32 is shown configured cylindrically (It is not essential in this example for 32 to be narrower than the general sheet width).

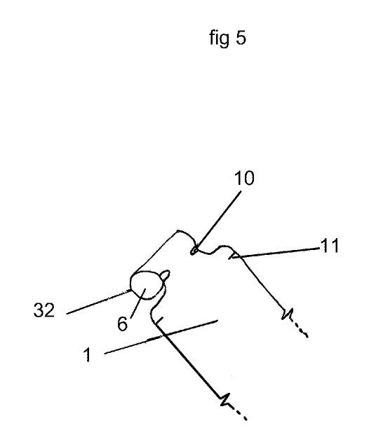

FIG. 6 Perspective view from the front/side and above. An example of a possible variation wherein a sheet of 1000 gauge thickness forms an anchorable Slide only, with the ends of the sheet fastened by stitching or a heat welding type of process across the width of the sheet.

FIG. 7 Perspective view from the front and to the side. An example of a 1-2 mm thickness sheet, when fully rolled up, as for carriage, storage, or as a cylindrical mould, wherein one retaining tab 10, is fully located, and one tab 10 is not located with a locating device 11.

FIG. 8 Plan view of the underside of an example of 1-2 mm thickness sheets, showing an example of an alternative means of retaining a sheet/s in a curved anchorage configuration, (shown before the curve is formed) suitable for use as an elongate Slide comprising a plurality of sheets.

FIG. 9 Plan view of the underside of an example of 1-2 mm thickness sheets, showing an example of an alternative means of retaining a sheet/s in a curved anchorage configuration; shown after the first end of the sheet becomes downwardly curved in configuration (relative to the surface of the slide), and is retained in position with a “clip on” linking strap/cord 12, passing around hinge 2, between a first sheet and an adjacent adjoining sheet of an elongate Slide.

FIG. 10 Plan view of the underside of an example of a 1-2 mm thickness sheet, showing a possible alternative means of retaining a sheet/s in a curved anchorage configuration for a Slide, after the first end of the sheet becomes downwardly curved in configuration, and is retained in position with a clip on, linking strap/cord 12, passing around/through a hook/loop 13, attached to the underside of a first sheet.

FIG. 11 Plan view of the underside of an example of a 1-2 mm thickness sheet, showing an alternative means of retaining a sheet/s in a curved anchorage configuration for a Slide, whereby the first end of the sheet becomes downwardly curved in configuration, and is retained in position with a male/female, direct clip together device 14.

FIG. 12 Perspective view from above and to the front side of an example of a 1-2 mm thickness; plurality of sheets in an example of a possible arrangement of the 2^{nd} embodiment Slide; with a bend created in the “sliding” surface of said Slide, whereby said first end of an adjacent sheet has a reverse lap flap 31, which is inserted through said letterbox slit positioned at the opposite end of a first sheet (or another adjacent sheet), also showing examples of primary anchorage means to a first end of a first sheet to sand; and narrower secondary anchorage means (32) arranged in an unused format, for cylindrically configured sand anchorage, but with holes 15 available for pegged anchorage. (normally invisible outlines of secondary anchorage portions of sheets 32 and tabs located at the first end of adjacent sheets are shown as dotted lines for clarity).

FIG. 13 Plan view of the underside 3 of an example of a 1-2 mm thickness; possible end unit positioned at the bottom of a plurality of foldably adjoined individual sheets, viewed from above, showing an example of an extra set of holes, wherein two sets of holes at opposite ends of an individual sheet are clipped together 16 forming a possible fastening means for a tear drop configuration 4.

FIG. 14 Perspective view of part of an example of a 1 mm thickness arranged set of sheets; as described in the 4^{th} embodiment; as a toy vehicle track, viewed from above and to the front side and including said “multi-lapped” arrangement 37, with junctions or forking of several connected tracks shown. Also showing part of a sheet arranged as a flyover, with a further track running below.

FIG. 15 Perspective view of an example of 1-2 mm thickness sheets arranged as a straight Slide of the 2^{nd} embodiment wherein the example is of a first sheet overlapping an adjacent attached sheet below, and said adjacent attached sheet is provided with means to be attached to a further adjacent sheet. Secondary anchorage means for Sand is not present on this example of an adjacent sheet. Normally invisible parts of sheets (e.g. Tabs at opposite end of a first sheet) shown by dotted lines for clarity.

FIG. 16 Front elevation of an example of a single tapered tubular anchorage peg, including a hook 18 which can be located through one of or more of the various holes 15 in one or more sheets, the tapered tubular pegs being particularly suited to insertion in loose/sandy substrates, and being adaptable to anchorage of other devices in similar substrates.

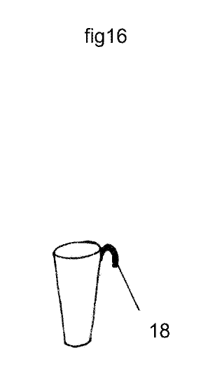

FIG. 17 Front elevation of two tapered anchorage pegs, stacked one inside the other for compact storage or carriage.

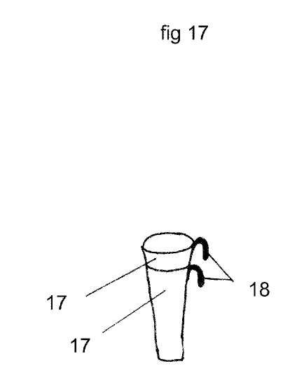

FIG. 18 Plan view showing the edges of three rolled up sheets of 1 mm thickness material, as described in an example of the 3^{rd} embodiment of the present invention (a variable diameter mould), showing an example of how, when the hollow centre of each is filled with sand, and they are stacked one on top of another, each having been rolled to a differing diameter, a tiered sandcastle could be made by using the sheets as moulds. (apparent gaps between walls of each roll have been exaggerated for clarity.)

FIG. 19 Front elevation of an example of a set of moulds similar in circumstances to FIG. 18, showing a fastening means wherein one tab 10 is located with a locating device 11 but an opposite tab is not located, creating a slight taper in the roll diameters, with the sheet forming the bottom tier showing a variation comprising an alternative retaining method for the roll, with both tabs being fastened with locating devices.

FIG. 20 Plan view of the underside of an example of an elongate Slide, wherein a plurality of sheets are attached by a single rotatable hinged fastening, also showing a secondary anchorage means 22 for Sand etc. extending the full width of a sheet, wherein an end to a sheet can be retained in a tear drop shape by connecting holes with a clips/rope etc. forming means for anchorage below an adjacent overlapping sheet.

FIG. 21 Perspective view of an example of a 2 mm thickness sheet arranged with a first end arranged in a tear drop configuration, as described in the first embodiment Sledge or Slide wherein said sheet shows possible cut out sections 28 for use as hand or footholds on a Sledge. The tube 4 may form a cushioned front portion 30 to a Sledge, or the tube 4 may be filled with substrate providing anchorage means at the top of a Slide arranged for example on Sand. Also showing a possible “shaped tail” and “wavy cut edges” 41, creating further constrictions in sheet width, which may be useful in fastening the opposite end 21 of a sheet to the area of the footholds 28 with, for example straps, thereby forming a shorter “double decker” Sledge, or for the purposes of carriage/storage.

FIG. 22 Perspective view of an example of a 1-2 mm thickness Sheet wherein both ends are arranged and fastened in a tear drop configuration, which may provide suitable cushioned ends to a Sledge, anchors to a Slide, or anchors to a “bridge” created between two Sandcastles. Also showing an example of possible possible positions for alternative cut out sections 29 which may be additionally provided as hand/foot holds if the sheet provided was for use as a Sledge only.

FIG. 23 Plan view of an example of 1-2 mm thickness sheets arranged on a grass/soil or similar substrate forming a possible Slide of the second embodiment, shown before being pegged down using traditional type pegs 23, as might be used for a tent. Also showing how, on sand it could be possible to use the specialised pegs 17 to secure parts of the Slide, by inserting the hooks 18 through holes 15.

FIG. 24 Side elevation of an example of a single 1-2 mm thickness sheet of the first embodiment arranged with top and bottom anchorage means to an underlying substrate such as Sand. (Sand is shown as a sheer face in order to show the Slide anchorage means in place). Also showing means by which the gradient at the beginning of a Slide may be made steeper due to a varied positional arrangement of said cylindrical configuration, or creation of a sandwich layer 9. (apparent sheet material thickness exaggerated for clarity).

FIG. 25 A Side elevation showing features of the second embodiment, (Sand shown as a sheer face in order to show anchorage means in place) wherein a plurality of adjoined, 1 mm thickness sheets are arranged and anchored on an underlying substrate such as sand with primary and secondary anchorage in place (viewed with Sand excavated in the area of narrowed secondary anchorage 32 in order to show secondary anchorage in place). Also showing fastening arrangements for two possible methods of lapping adjacent sheets; (sheet material thickness/gaps between sheets may be exaggerated for clarity).

FIG. 26 A Side elevation showing features wherein an example of a plurality of adjoined 1 mm thickness sheets is arranged with multi-layering 37 of said sheets, for the purpose of creating a toy circuit or track as described in a fourth embodiment of the present invention and showing examples of “flyover,” “tunnel” or “hill” 40 creation, by arrangement of sheets in teardrop 4 or cylindrical configurations 6.

FIG. 27 Plan view of sheets joined and configured using a tabs 10 and locating device 11 system, arranged as a toy track (4^{th} embodiment), with possible example of graphics 38, and additional preformed tight corner pieces 35, as well as flyovers and tunnels etc.

### DESCRIPTION OF PARTS LABELLED ON DIAGRAMS

1. Top surface of a sheet.

2. Rotatable hinge forming foldable adjoining of adjacent sheets.

3. Underside of a sheet.

4. Tear drop configuration to an end portion of a sheet.

5. Locating device, positioned other than at right angles to a sheet edge, such that an attached sheet will create a bend in an elongate sheet.

6. Cylinder configuration to an end portion of a sheet.

7. A completely rolled up cylinder configuration for carriage/possible use as a cylindrical mould.

8. A downwardly curved configuration to a first end of a first sheet as retained with one of various examples of a fastening means.

9. An area for the addition of extra “trapped sand” or similar substrate in a sandwiched arrangement, formed in order to create a steeper “dropslide” area at the top of a Slide.

10. Tabs as used as part of a described integral fastening means, comprising a tabbed part of a sheet edge with a slit; having an inwardly facing opening; the width of slits being generally no more than the general sheet thickness of a sheet.

11. Locating device as used as part of a described integral fastening means; comprising a slit with outwardly facing opening at edges of a sheet; the width of slits being generally no more than the general sheet thickness of a sheet.

12. Cord/strap of one example of an alternative fastening means.

13. Hook/loop of one example of an alternative fastening means.

14. One example of an alternative fastening means involving a type of press stud.

15. Holes provided in sheets, used for attachment of clips or anchorage pegs as required.

16. Example of an alternative fastening means wherein clips hold two parts of a sheet or sheets together in chosen configuration.

17. Specialist tapered sand tubular anchorage peg.

18. Example of hooked over part of an anchorage peg, for locating in a hole in a sheet.

19. A variation in possible overlap shape at the end of a sheet which includes integral fastening means.

20. The first end of a sheet.

21. The opposite end of a sheet.

22. Example of a full width extended first end to a sheet, partway along a chain of connected sheets allowing the option for an additional secondary anchorage point.

23. Traditional tent type pegs with a smooth, rounded top, for pegging a Slide down to grass/soil or similar.

24. Sand or similar substrate.

25. Grass/soil or similar substrate.

26. “Letterbox” system for reversing direction of lap between sheets.

27. Area which may require “banking” inserts, either man made and provided, or created by altering the profile of the underlying substrate manually.

28. Shaped cut outs at the edges of the sheet, providing foot/hand holds.

29. Cut out holes in sheet providing hand/footholds.

30. Leading cushioned portion of the sheet when used as a Sledge.

31. Reversed lap flap.

32. An example of an extended first end of a sheet, wherein a narrowed portion of sheet is provided with secondary anchorage means.

33. First sheet of a plurality of adjoined sheets.

34. Adjacent sheet of a plurality of adjoined sheets.

35. An example of a preformed sharp bend.

36. Example of a narrowed area of sheet, or lengthened Slit; where an adjacent sheet is to be fastened, thereby creating a bend or curve in said track/slide surface.

37. Multi layered area of sheets.

38. Example of applied graphics.

39. An increased gradient due to varied position of cylindrical anchorage means.

40. Flyover, Bridge or tunnel created as part of a track system.

41. Wavy shaped edges and tail to the opposite end of a sheet.

42. A stitched seam line, or heat welded seam line forming a configured end portion to a sheet.

The aim of the present invention is to create a multi use sheet/s which is able to successfully perform the roles of a range of desired, predominantly fun objects as described herein, including means of retaining a portion or portions of the sheet/s in the various configurations herein described, the configurations retained forming an essential part of the present invention, for example, forming anchoring means, cushioning means, formation of self supporting structures (bridges and flyovers as part of a toy track) or adjustable diameter substantially circular enclosures, which when stood on their side may be used as a mould for creating Sand, Snow or similar structures. In a further aspect to the present invention, the configurations formed, may be temporarily retained by the engagement of integral, releasable fastening means positioned on said sheet/s, or on similar, adjacently positioned sheets. Said sheet/s in achieving the above aims; preferably remain simple to produce, store and carry with a minimum of loose parts or accessories, which would easily be lost in sandy or similar environments, or present a hazard, for example to users aged under three years old. A number of possible embodiments of the present invention may be desired, each having various dimensions which may be preferred, and either a single sheet or a plurality of adjoined sheets employed for a desired role, such that the sheet or sheets; in a given role are suited to the requirements for various age groups or other needs of a user; These embodiments and variations to the present invention will now be outlined and described in further detail with reference to the attached drawings.

### DETAILED DESCRIPTION

### First Embodiment (Preferred Mode), Slide/Sledge

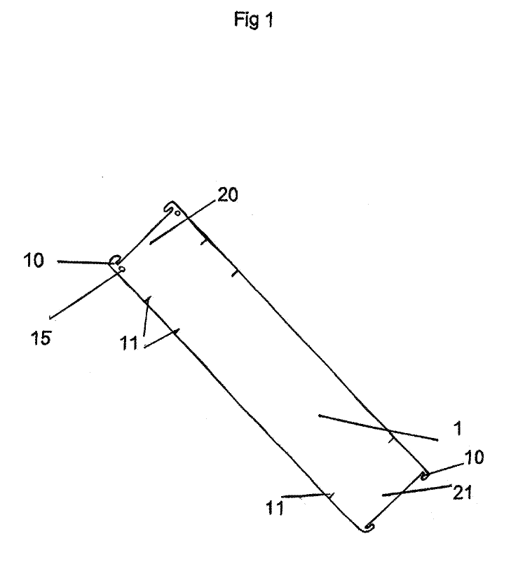

A first embodiment of the present invention is also the preferred mode and comprises a single sheet with fastening means for example tabs 10 and locating devices 11 (comprising narrow slits in the edges of the sheet/s) as shown (FIG. 1) such that at least one end of said sheet can be configured and re-configured for example as shown in FIGS. 1,2,3,7,21,22,24, wherein a plurality of such configurations are possible by altering the number and positioning of tabs 10 and locating devices 11 on a sheet as desired, to offer benefits for the proposed uses described herein and some further uses which will become apparent.

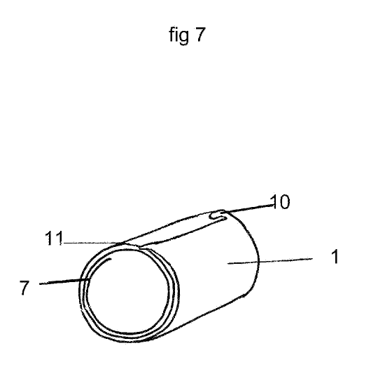

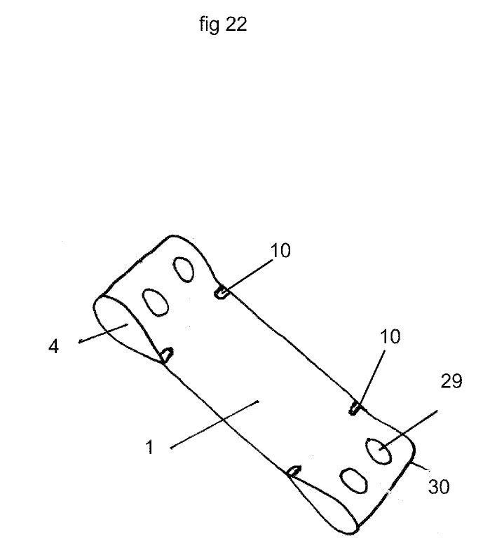

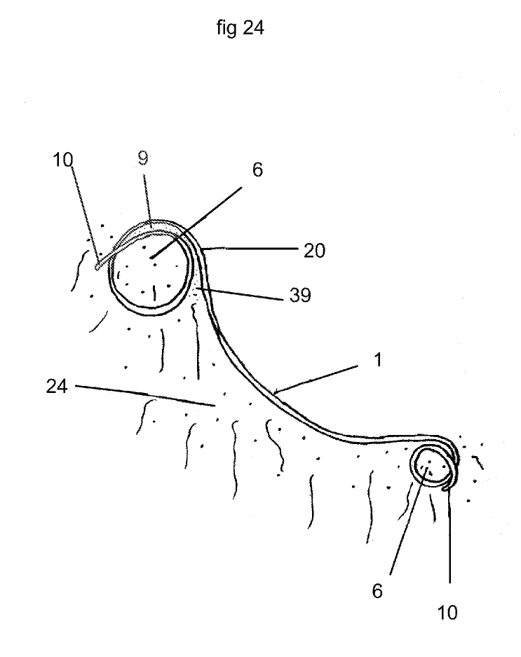

FIG. 1, shows a variation to a sheet wherein said fastening means in the form of tabs are present at both ends of said sheet, such that both of said ends can be re-configured for example as shown in FIG. 7, FIG. 22 and FIG. 24, which may be desired in the example wherein the role of said sheet is that of either a Slide (requiring anchorage at both ends, on for example sand), or a Sledge, requiring a curved section at both ends (which means the Sledge may be used either way round).

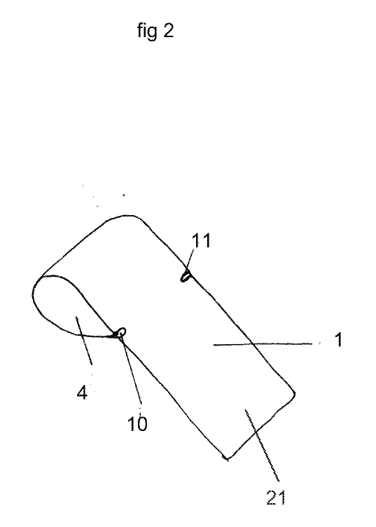

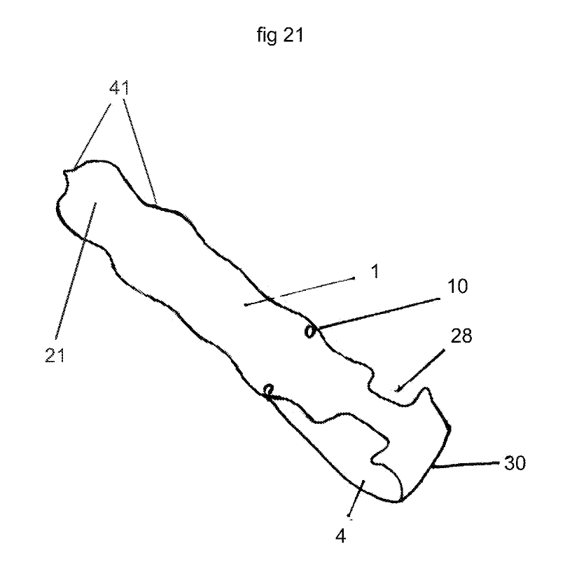

FIGS. 2 and 21 show a further possible variation with said tabs at one end of a sheet only, as in the example of a sheet performing the role of a Slide (anchored by said configuration 4 at one end of a sheet being filled or buried in an underlying substrate), Otherwise, In a further example of a role for such a sheet (FIG. 21) said teardrop configuration 4, forms a front curve 30 held under tension by said fastening means such that said sheet thus configured performs the role of a Sledge with only one curved end portion, the opposite end being configured as a trailing flat sheet. Such a Sledge is suited to use on, for example, Snow, Sand or grass; and may also be used in the way of a Bobsleigh, over a surface comprising a further sheet or sheets of the present invention, arranged in the role of a Slide/elongated Slide. FIG. 21 also shows an example of specially shaped cut out areas 28; as may be provided, positioned such that they may provide hand or footholds to a rider sat or otherwise positioned on the top surface 1 of said sheet during use as a Sledge. An example of a possible alternative set of said Hand/foothold cut outs can be seen 29 on FIG. 22. Further cut out shaping to the edges of said sheet for the purpose of enhanced looks to a sheet; such as the wavy edges and pointed tail 41 shown on FIG. 21, demonstrate how the looks of a Slide or Sledge can be customised in design if desired. It should be noted that the example shown in FIG. 21 could also be used as a Slide as previously described, with the level of success in both roles (Sledge and Slide) being subject to an appropriate choice of sheet thickness/strength relative to the other proposed dimensions of said sheet, and the proposed weight and size of proposed users. For example approx 2 mm thickness of HDPE at a sheet width of approx 500 mm, provides adequate strength for both uses (Sledge and Slide) and most “average” users, whereas a 1 mm thickness HDPE sheet, otherwise similar, may be strong enough to anchor a Slide, but not strong enough to provide a Sledge of adequate strength for repeated use. However, 1 mm thickness sheet may be adequate for use both as a Slide and Sledge of half the width, suitable for a user of half the weight of that mentioned above, (for example in use as a Toddler Slide or Sledge). A Sledge as herein described, may be required to perform the role of an expedition Sledge, for example to be used when carrying beach goods, or indeed any other goods upon the body of the Sledge. During the role of expedition Sledge, unusually abrasive surfaces may be encountered including sand/tarmac or concrete, which could necessitate an accessory to the Sledge, in the form of an additional replaceable wear plate.

FIG. 24 shows an example of the benefit of re-configuring a sheet into a cylinder for anchorage at the top of a Slide on for example Sand. The additional sturdiness of the cylinder 6 due to the round shape reducing potential movement of sand within, and the extra height achievable by setting the cylinder partially protruding above the general level of surrounding Sand, allows a steep initial face 39 to the first end 20 of a sheet. This steeper than usual face may be desirable to a user for creating the effect of a “drop slide”, or otherwise increasing initial acceleration of a user on the Slide surface, and may include an additional “sandwiched layer of sand 9, as can be seen in FIG. 24, creating a gradient at the top of the Slide, which is much steeper than the natural gradient existing on the Sand dune or other heap of Sand chosen to support the Slide. The opposite end of said sheet of FIG. 24 also has fastening means, demonstrating a smaller anchorage cylinder (by using differently spaced locating devices along said sheet edges). A cylinder at the bottom of said Slide may also be used to help retain the sand in a jump configuration, by arranging said cylinder similarly to said top of Slide (Partially protruding from surrounding surface). A Slide anchored at a first end only may have an opposite end overlapping another Slide/s anchored similarly; forming a longer Slide surface.

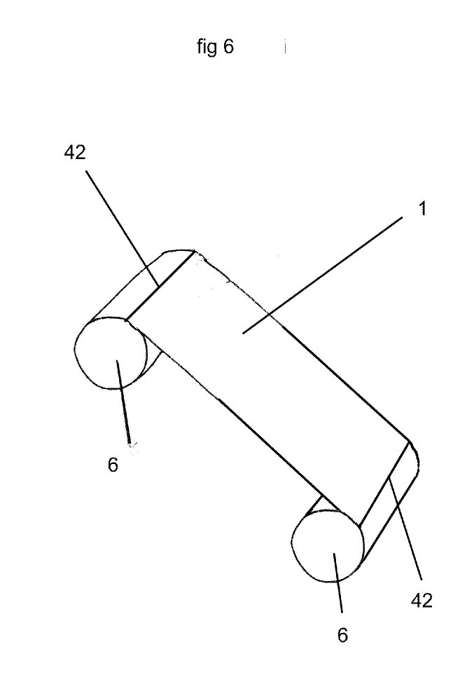

It should be noted that a sheet able to perform the role of a Sledge and a Slide without the sheet being re-configurable (requiring a temporary fastening means); is possible, for example if a teardrop or cylindrical configured portion is formed permanently at the first end of the sheet, for example by being welded 42 or preformed/welded with heat (FIG. 6). The remaining portion of the sheet could still be rolled around the teardrop or cylindrical portion and secured, for example for carriage (or as a mould).

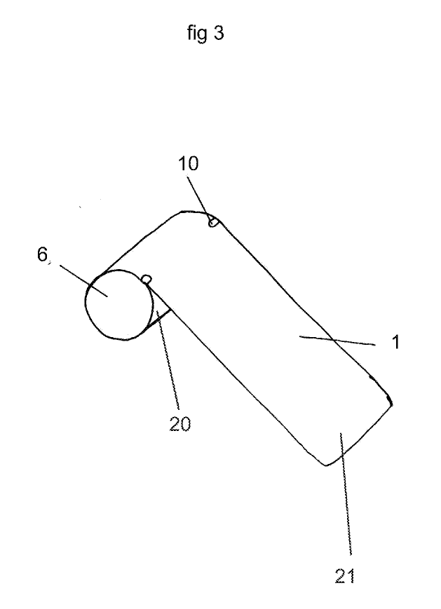

It should also be noted that in the variation wherein the first end of a sheet is temporarily fastened in a desired configuration using means such as, for example, tabs and locating devices, then it is preferred that the configured portion is formed substantially below the sheet surface 1, with the tabs ending up above the sheet surface 1 as shown on FIG. 2 and FIG. 21, this is important where the proposed uses of the sheet are both a Sledge and Slide, as the preferred way of arranging a Slide is as shown in FIGS. 2 and 3, with sheet surface 1 uppermost, and it should be noticed that the Sledge (FIG. 21) is also used with the surface 1 uppermost, thus the underside (bottom) of a Sledge (which may be scratched and scored is also the underside when said Sledge is arranged for use as a Slide anchored to an underlying penetrable surface.

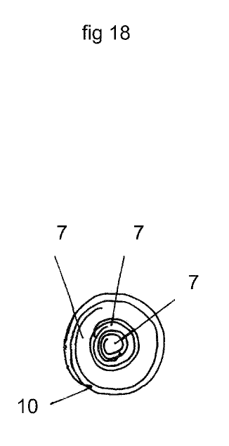

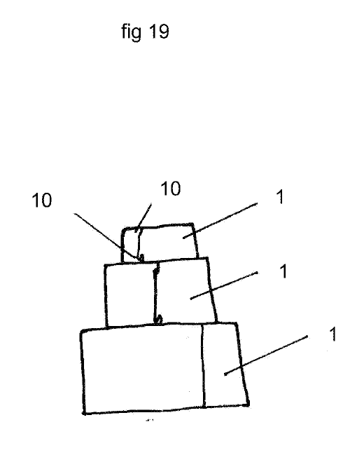

For storage or carriage, a sheet can be rolled up as shown in FIG. 7, with for example, one of the tabs interlocking with a locating device 11 to retain the sheet in this fully rolled cylindrical configuration 7, creating a tidy bundle. Alternatively, a strap could be used to retain the sheet in a roll. However in a further aspect, a sheet substantially as described rolled up and fastened in this way can also provide a further recreational use, providing a mould when the roll is placed on its side on a surface as shown (FIGS. 18 and 19). This idea will be further described separately when considered as a third possible embodiment herein.

### Second Embodiment

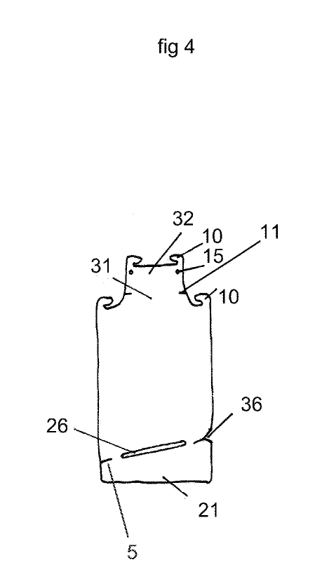

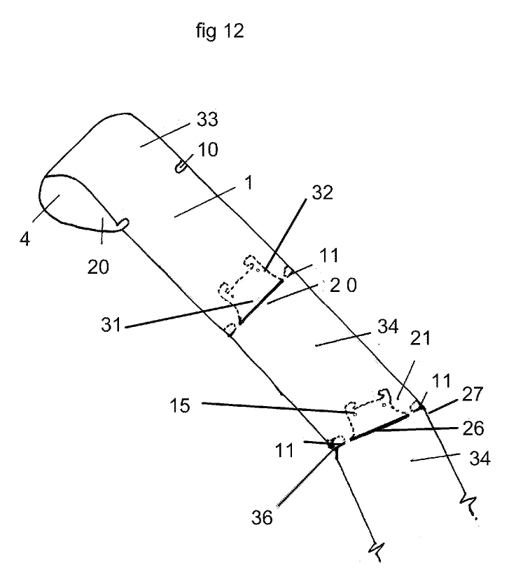

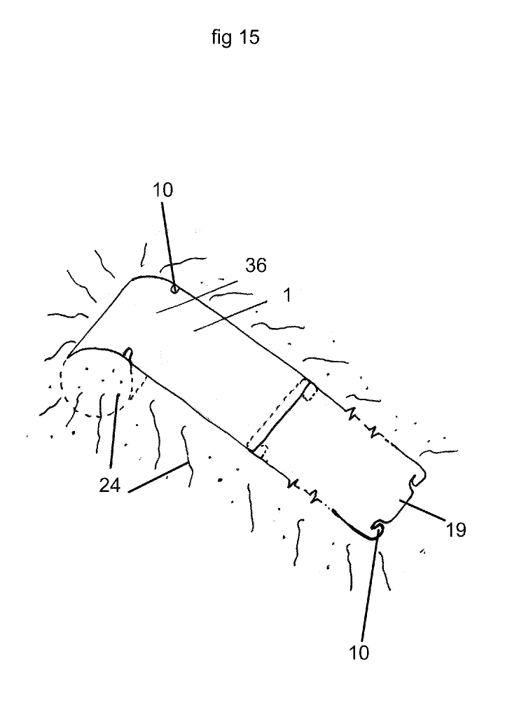

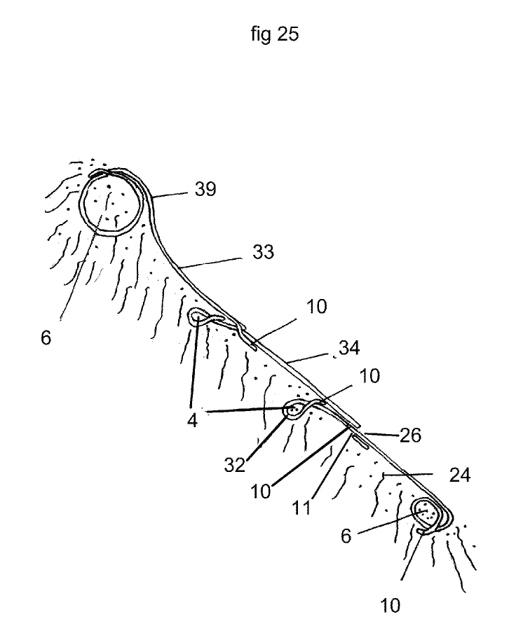

In a second embodiment of the present invention, the proposed role of the Sheet is that of a Slide similar to that of the first embodiment, with, in addition, further similar attached or attachable units which together with the first unit, form a lapped, elongated, portable Slide; anchored to and supported by an underlying substrate such as sand, grass or bare earth. Where a plurality of similar sheets are provided, each of said sheets is able to be lapped with an adjacent sheet or sheets, and attached in position, the means of attachment preferably comprising fastening means for example those already described herein such as tabs 10 and locating devices 11 (FIG. 1 and FIG. 25). Said fastening means are therefore dual purpose wherein they may be used as a means of attachment to another sheet and also being able to be used to form desired configurations which may be used as anchorage means, for example tear drop 4 or cylindrical 6 (suitable for example for sand 24). FIGS. 12, 15 and 25 show how tabs 10 on a first sheet, may be interlocked with locating devices 11, either on the same sheet or on an adjacent sheet. In an example of such an elongate Slide (see FIGS. 12 and 25), the first end 20 of a sheet positioned at the top of said Slide and the opposite end 21 of a sheet positioned at the bottom of a Slide, have tabs 10 which are temporarily interlocked with retaining devices 11 forming a downwardly curved, tear drop shaped enclosure 4 or cylindrically shaped enclosure 6, depending on which way the tabs face when located, (FIG. 2 shows tabs 10 facing the opposite end 21 of the sheet; i.e. the tab being below the locating device 11. FIG. 3 shows the tabs 10 facing the first end 20 of the sheet; i.e. The tab being above the locating device.) These configurations form tubular pockets for primary anchorage of said top and bottom of Slide in loose substrates such as Sand or Snow, wherein the centre of a tube created is filled or buried in surrounding substrate 24 (FIG. 15). In the example of a cylindrical configuration 6, a steeper face 39 to the initial part of the slide can be also formed if required, this can be maximised by having a minimum portion of said filled cylinder actually below the surrounding general surface level (see FIG. 25), and adding an extra sandwiched layer of sand 9 (FIG. 24). More than one set of tabs 10 and retaining devices 11 may be positioned as required for additional uses as described later (see FIGS. 1 and 4).

FIGS. 12, 15 and 25 also show examples of two variations in the way that tabs and locating devices may interact for the purpose of adjoining a plurality of said sheets in formation of an elongate Slide. FIG. 15 shows a preferred simple system whereby said first sheet generally overlaps said adjacent sheet below, tabs 10 being located below the under surface of said adjacent sheet when fastened to co-operating locating devices 11.

FIG. 12 shows an example of attachment between sheets, when arranged in a different way (dotted lines show the outline of portions of said first end of adjacent sheets which are hidden and covered by another attached sheet, for clarity of description). This arrangement forms a strong but more complex form of attachment, wherein said adjacent sheet 34 initially appears to overlap said first sheet positioned further up the Slide. However in this system an additional “letterbox Slit” 26 is required (FIG. 4) to be positioned at said opposite end 21 of each sheet that is required to provide attachment in this way, such that the first end of an adjacent sheet 34 can be tucked through said letterbox 26, of said first sheet 36 (FIG. 12), thereby reversing the direction of overlap between sheets across most of the width of the sheet (Tabs at the first end of the adjacent sheet are also fastened ending up below the underside surface of said first sheet). Of course; should any number of further additional sheets be desired for said elongated Slide, then further adjacent sheets can be attached together for example, in either of the ways herein described; chosen method depending on strength requirement, and cost issues of commercial production.

In addition to either of the previously described attachment methods for adjacent lapped sheets, a secondary anchorage means 32 or 22 may be provided at each joint between sheets if sufficient overlap between sheets is provided. This would require for example additional tabs and locating devices arranged in tear drop or cylindrical configurations, to be filled with substrate (for example sand) below the surface of an adjacent sheet. Alternatively (for secondary anchorage on grass etc.), other anchorage means such as holes for tent pegs 15 as shown (FIG. 4) positioned at said first end of a sheet may be used. Due to the lapping between adjacent sheets described herein, said secondary anchorage means are able to be hidden below said surface of a Slide as can be seen FIG. 12, thus protecting users from snagging on pegs etc. during use.

Where bends in a Slide run are desired, in the example of an elongate Slide comprising adjacent units attached by, for example, tabs and locating devices, said locating devices may vary to those shown in FIG. 1 as can be seen 5 (in FIGS. 4 and 12); wherein said locating devices are not at right angles to the sheet edge on which they are positioned and additionally, a small cut out 36 at one side of sheet may be required in order to attach an adjacent sheet of the same general width (alternatively the Length of a locating device “slit” must be increased); as can be seen in FIG. 4 or 12. Said bends are achievable in the way herein described, whichever example of said “means of attachment to adjacent sheets” described in the earlier paragraph is considered. Said bends may also be in either direction, and of varying degrees of sharpness according to positioning of locating devices.

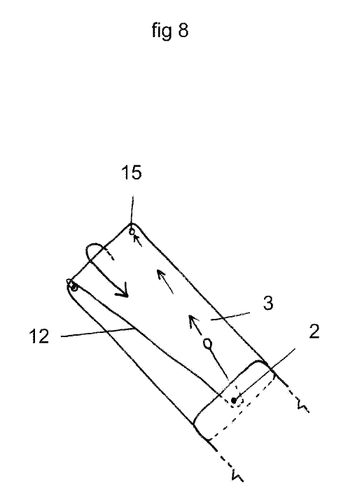

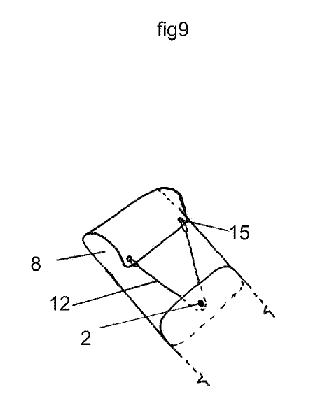

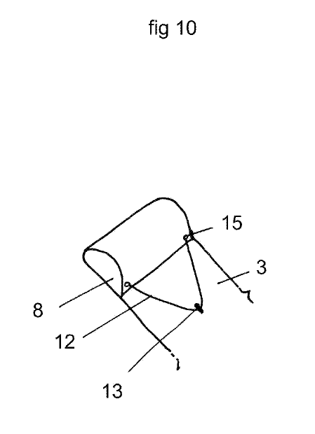

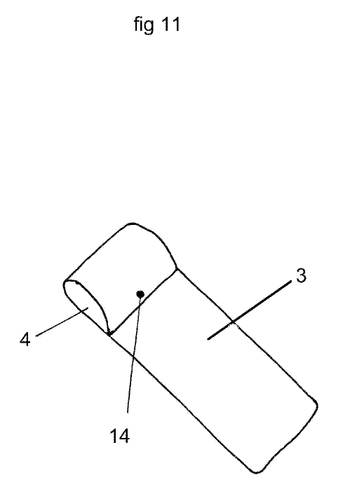

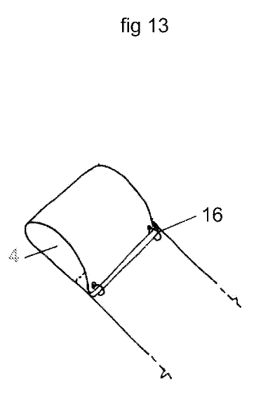

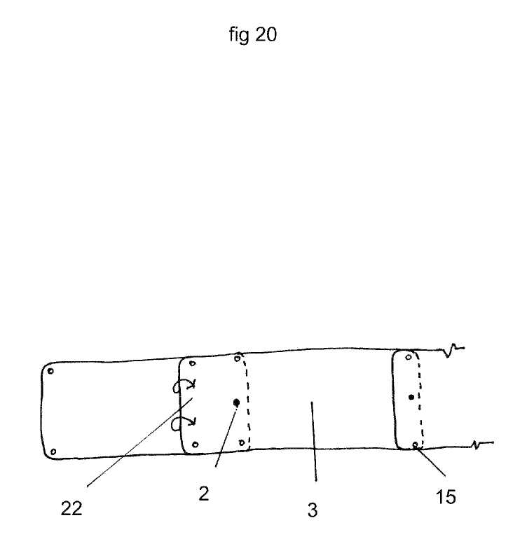

Further examples of possible alternative non integral fastening means between sheets and means to create said configurations for anchorage can be seen in FIG. 20 wherein a single fastened hinge point 2, provides the means to fold and unfold overlapped sheets or create bends in the Slide run during use, and FIG. 13 wherein holes in overlapped sheets may be connected by clips 16 creating a teardrop configuration 4. FIGS. 8-11 show other examples of fastening means for retention of a sheet and formation of chosen curved 8 or teardrop configurations.

When arranged as described, with said plurality of sheets performing the role of an elongated Slide, there is the flexibility for the apparatus to smoothly cover underlying “jump” contours or banking at corners, which may be incorporated into the Slide run, either by modifying the underlying substrate (manually), or by adding some preformed, manufactured contours/banking elements (for example; expanded polystyrene jump ramps).

Fastening means described may be varied or mixed to suit requirements, for example strength requirements may lead to inclusion of both a single pivoting hinge 2 and a tab and locating device or other such system to attach adjacent sheets to one another.

An example of preferred dimensions and material used in this embodiment would be: Sheets of 1 mm thickness high density polyethylene (providing lightweight, easy rolling for carriage etc.) and with other dimensions of each sheet being: 2 metres long×500 mm wide, but any of these dimensions may be varied, or sheets of mixed measurements used.

### Third Embodiment. Ref. FIGS. 7, 18 and 19

In a third embodiment of the present invention, said sheet/s can be used in the role of a variably sized mould, for example to help build Sand structures or fulfil roles of other Sand play or Snow play objects (including Snow towers, and moulded Slides wherein the mould remains in position during use). Said chosen configurations of the present invention including tear drop 4 and cylindrical 6, when applied to a sheet/s of material of dimensions for example: of 1 mm thickness×1.5-2 metres long×100 mm wide will allow said sheet/s to successfully perform a number of roles as will herein be described.

A variable sized mould in the given examples of the present embodiment, refers to a recreational Sand or Snow mould using tabs/locating devices, thus reasonable limitations to the size of a finished structure and to the dimensions of a mould may apply. The thickness of a sheet being preferably 0.5-1.5 mm, in order to allow tight rolling of a cylinder for moulding small diameter structures, but industrial uses requiring larger/stronger moulds are possible.

A plurality of sheets adjoined as previously described herein; using a tabs 10 and locating device 20 system, may be formed into a large diameter mould, of for example, a circular shape; by the fastening of a first end of a first sheet with the opposite end of the final sheet (of a previously adjoined chain of sheets), using said integral releasable fastening means (tabs and locating devices). The resulting circle is formed by positioning said sheets on a surface such that a side edge of the sheet faces downward. Said mould is then filled; with for example Sand or Snow, forming the desired circular shape. Said sheet/s herein described may be adjusted in diameter by engaging co-operating fastening means positioned at various points of a sheet, with the result that for example; a tiered structure may be easily and neatly built (see FIGS. 18 and 19).

In a further possible use of a sheet of this embodiment a sheet may have its ends configured as shown 4, in FIG. 22 such that one tear drop configured end can be buried within a tier of said sand/snow structure during construction of a multi tier structure, the other end can be similarly buried in a similar sand structure built close by, with the surface of said sheet forming a bridge in between, the bridge being anchored in the sand/snow and strengthened by said buried configured tubular ends 4.

Towards the top of a tiered structure or when a narrow diameter mould is desired, or for tall tower building (snow structures or sand), a method may be employed of slipping the mould partially upward over the existing filling, and then refilling the top part of the mould. This can be repeated until a desired height is reached. For such narrow diameters in particular, it may be advantageous to fasten the mould using only one of the tabs as shown FIG. 7. This has at least two advantages: A single tab is much easier to fasten and release than a pair of tabs: This is because; in order to fasten twin tabs, the sheet needs to be manually flexed or “sprung” in the area of the locating devices, creating a temporarily narrower sheet width at this point (and concave or convex shape). The narrowed locating device portion of the sheet can then easily be located between the slits of the two tabs before the previously flexed area is released, thus fastening the tabs and locating devices portions of a sheet together. A single tab fastening may be engaged by merely moving the tabbed portion and the locating device portion of a sheet into a position where the sheet edges are parallel and the tab is located with the locating device. To unfasten, the reverse of fastening applies. Thus a single tab fastening allows the mould to be released simply by releasing the sheet edges from parallel alignment with one another, and then peeling the mould away from the contents of the mould without the need to flex any part of the sheet in a concave or convex way. Also, a single tab fastenings allows the mould to have a slightly tapered diameter (see FIG. 19) from top to bottom of the mould. (the mould being tighter under internal forces where fastened by a single tab, than where no tab is fastened). This slight tapering may be advantageous when removing the mould or moving the mould by slipping the mould upward over the contents of the mould.

The rolling procedure of moulds for carriage as can be seen in FIG. 7. is generally the same as procedure for forming a cylindrical mould. Importantly, a mould with a tabs/locating devices or similar system, is also able to form a crescent moon shaped mould for example, by forming a small cylinder at the first end of a sheet 6, then curving the remaining portion of the same sheet back around said cylinder, finally forming a crescent when tabs located at the opposite end of said sheet are joined with locating devices positioned part way round said previously formed cylinder; Said cylinder remains empty during the moulding process. This system involves part of both surfaces (1 and 3) of a single sheet simultaneously being used to face and retain moulded material in the desired shape.

The sheet/s described in this third embodiment also offers the possibility of using said sheet/s to fulfil the role of a toy version of a Slide, similar to the Slide as described in the first embodiment: A Slide created from a mould sheet could be classed as a “Toy Slide”, if a Toddler or young child uses the provided sheet in the same way as described in the first embodiment herein (as a Slide), that is, surface mounted on a pile of Sand (for example), forming a mini Slide (for example 100 mm wide×300 mm long 1 mm thickness plastics), the child could then pretend it was a Slide built for his/her small Teddy Bear or Doll.

A Mould sheet provided with a set of dimensions of for example: 1 mm thickness×2 metres length×250 mm width, would mean the sheet could easily be configured, arranged and used; as described in the first embodiment, fulfilling the role of a childrens Slide with anchorage means to an underlying surface. Also, an elongate Slide, created by joining adjacent sheets together using tabs and locating devices (slots) can be made from mould sheets, in generally the same way as described in the 2^{nd} embodiment herein. The reduced dimensional width and thickness of sheets in examples of this (3rd) embodiment relative to those dimensions proposed under examples give in the first embodiment, could be beneficial if the user is considered. The proposed user age group for this (3rd) embodiment being for example 3-8 years old, whereby body size and weight of user is low in comparison to older users. Furthermore, in the example of anchorage to sand, a smaller Slide could be anchored to a man made heap of sand (at the beach, or in a sandpit), built to a desired shape, dimensions and gradient by a builder, (subject to the constraints of said mould). In addition, the Slide of this example would comfortably fit with the role of a mould suitable for use by smaller children, alongside the example of the 100 mm wide moulds, perhaps as part of a set, suitable for example for general sand play either in a garden sandpit, or on a sandy beach.

The narrower dimensionally the examples of sheet width described in this (3rd) or any embodiment herein, the more required force for flexing of the sheets into a concave shape (to locate tabs with locating devices) may be necessary; if the example of the tabs and locating devices fastening means is selected as the preferred fastening means of sheet/s. This flexing is achieved by applying simultaneous pressure to the side edges of the Sheet creating a concave or a convex shape to the sheet. The requirement to be able to flex a narrow sheet in this way may restrict the thickness of sheet that is chosen for a particular role, for example a 2 mm thick sheet is not suited to use as a 100 mm wide mould as it may be too difficult to flex adequately for the location of tabs with locating devices.

### Fourth Embodiment

The sheet/s of the present invention in a fourth embodiment are able to be configured as previously described in the previous embodiments herein, preferably using integral fastening means at one or both ends of a sheet; such as the tabs and locating devices previously described herein. Each sheet in this embodiment performs the role of a section of track, inter connectible with other similar sheets and being composed for example of: 1 mm thickness HDPE (high density polyethylene); of width 100 mm and lengths varying between 500 mm-2 metres. These dimensions tally in width and thickness with an example of the third embodiment, such that they (sheets of the 4^{th} embodiment), may be used in conjunction with or connected to said 3^{rd} embodiment examples of a sheet, or for example, as a direct replacement to a sheet of the 3^{rd} embodiment in a proposed role, or vice versa.

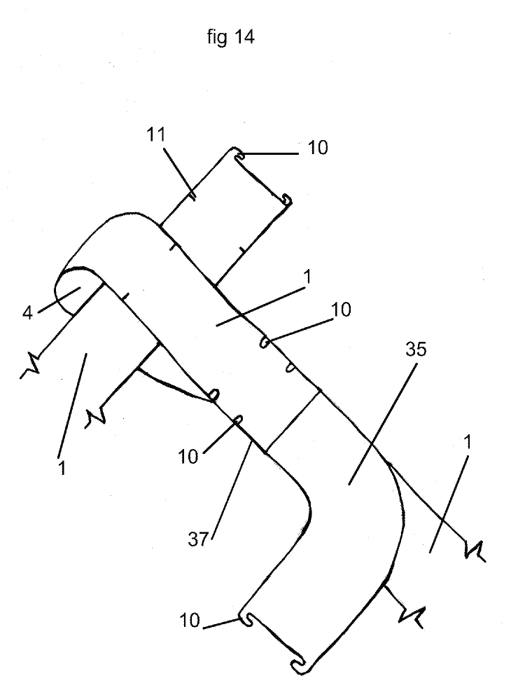

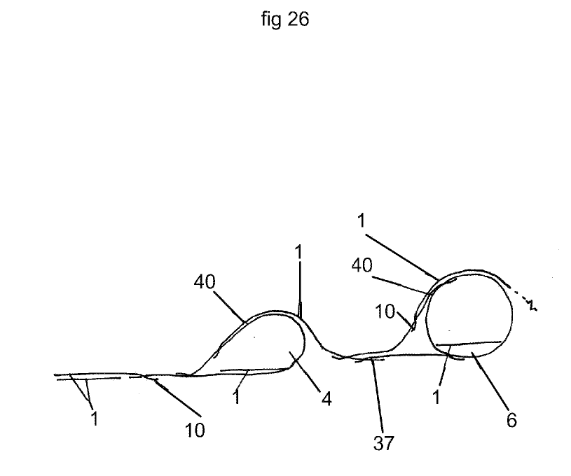

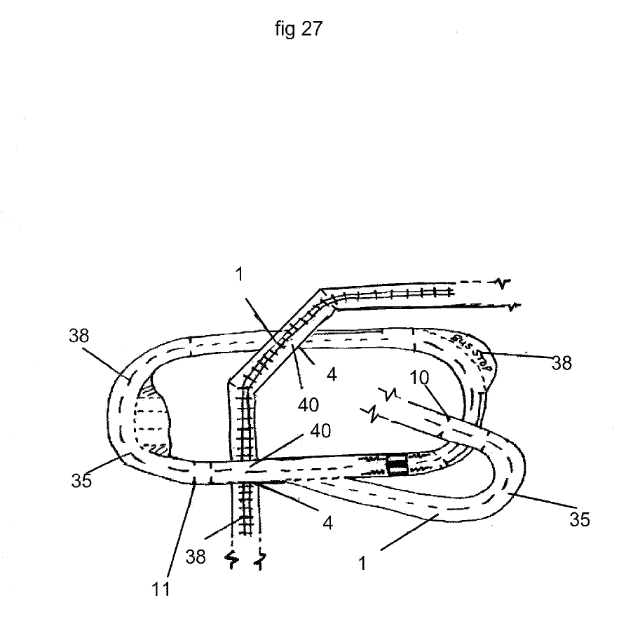

Although lapping and connection of adjacent sheets has been described herein, (second embodiment), multi layering of attached sheets has not extensively been described previously herein, (FIG. 26, FIG. 27 and FIG. 14). Said multi layering 37 is an important feature of this embodiment of the present invention, but may also be employed as part of the 2^{nd} embodiment, should for example forking of a single Slide into a plurality of Slide tracks be desired. Said multi-layering refers to the instance whereby more than two sheet/s are lapped at some point and may require fastening of said sheets to adjacent sheet/s as shown FIG. 14, thereby forming junctions wherein said sheet surfaces may continue in various directions; by attaching sheets forming bends using angled locating devices 5. In this way a continuous track can be formed, with multiple track surfaces being created subject to available fastening means, said multiple tracks can also be formed into junctions whereby they converge back into for example a single track, with the opposite end of a final sheet of one such multiple track section ending beneath a remaining continuing track surface (with no requirement to be attached at this point). Furthermore, as can be seen in FIG. 14, the surface of one section of track may pass through a tear drop configured area 4 of another sheet which has been arranged and fastened in that desired configuration, said tear drop configuration thus forming a self supporting flyover or tunnel 40, over the section of track which passes through said tear drop tube 4 (at varying chosen angles). Said tear drop or cylindrical configuration at either end of a sheet may also form a hill, over which another attached sheet can run and continue down to original surface level, thus self supporting hills can quickly and randomly be created within a system of arranged track sections connected by engaging tabs 10 with variously positioned locating devices 11 on the same sheet, or adjacent sheets. In addition to the predominantly oblong track sections of the present invention as previously described herein, additional, specially shaped pieces such as right angled bends 35 hairpins etc. inter connectible with other track sections herein described may be supplied in order to complete a track of a desired design (FIG. 27), gentle bends can be formed simply by connecting tabs of one track section to locating devices formed at other than right angles 5 to the edges of another sheet. A partial or completed track would suitable for the movement of for example toy cars and other vehicles by young children, when set out on a surface indoors or out, and could be used in conjunction with sand play items created and described in the third embodiment of the present invention such as bridges between tiered Sandcastles. Track may also be used in conjunction with tiered Sand structures, hand finished with sand ramps between tiers such that continuous toy movements are possible around the tiered sandcastle as though driving up and around a mountain; across bridges suspended as described above using track sections, between two tiered sandcastles; or movements between Sand tiers and track sections arranged for example around the garden.

In the example of track made from HDPE plastics material, a proportion of said track sections may have additional side mouldings wherein part of a section is wider than another part, such that lay-bys, bus stops, parking spaces may be created. Track sections may be further enhanced by either pre-printing permanent graphics 38 onto track sections, or allowing/encouraging the user to add their own desired graphics including road markings with for example a set of permanent markers, which are reasonably hard wearing, but can easily be removed from HDPE using for example methylated spirit or thinners, whereby road markings can quickly be changed or replaced by the user as desired. In addition to said road markings, other graphics, for example railway line graphics (sleepers and track) are easily created, allowing the user to customise their own track circuits using their imagination and for their enjoyment.

Depending on the width of track sections, track may be used to create Slides similar to those described in the first and second embodiments, or to create Toy Slides as described in the third embodiment. Narrow track including anchorage means (as previously described herein), may also be used to form surface sports pitch line markings; for example on Sand.

### Fifth Embodiment

In a fifth embodiment of the present invention, use of said sheet apparatus is, as a pillowed waterproof surface covering, the pillow created by the configuration 4 at the end of a sheet. This suggested role would be of use when relaxing on a damp or dirty surface.

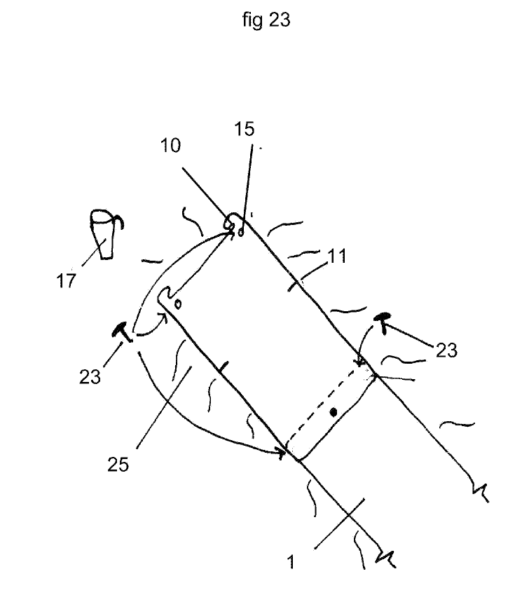

FIG. 20, and FIG. 23 show, possible additional features including an example of a full width secondary anchorage means 22 for possible use on an elongate Slide. FIG. 23 shows round topped pegs 23 for use pegging a sheet through holes 15, to grass or similar 25.

1. A Slide comprising at least one substantially oblong sheet of flexible material, with means of anchorage to an underlying, supporting, penetrable surface, wherein a means of anchorage includes at least one end of said sheet arranged to form a curved, teardrop or cylindrically configured tubular enclosure, with said tubular portion arranged substantially perpendicular to the general longitudinal axis of the sheet such that said enclosure is incorporable with the underlying substrate to form anchorage of the Slide.

2. A Slide according to claim 1, wherein the complete Slide comprises a single sheet of a desired length, width and thickness.

3. A Slide according to claim 1, wherein said anchorage is provided at one end of each sheet only.

4. A Slide according to claim 2, wherein said means for anchorage is provided at both ends of the sheet.

5. A Slide according to claim 2, wherein said means for anchorage is permanently formed and located at at least one end of a sheet.

6. A Slide according to claim 1, wherein at least one means for anchorage includes temporary fastening means of a sheet, such that the sheet, can be configured; and can be released and reconfigured.

7. A Slide according to claim 3, wherein the Slide comprises a plurality of lapped sheets, forming an elongate Slide.

8. A Slide according to claim 6, wherein said temporary fastening means when present at an opposite end of a sheet, may be also used to form attachment to similar, co-operating fastening means, located on adjacently positioned, lapped sheet or sheets, said attachment of at least one of said sheets resulting in the formation of an elongate Slide.

9. A Slide according to claim 5 including said means of anchorage provided at only a first end of a sheet, wherein the opposite end of the same sheet is not provided with said anchorage means.

10. An elongate Slide according to claim 8, wherein any adjacent sheet includes means for the provision of secondary anchorage of the Slide to a penetrable surface, the secondary anchorage means locatable beneath the overlap of another sheet of the Slide.

11. An elongate Slide according to claim 8, wherein a first, adjacent and any subsequently attached sheets are arrangeable to form an elongate Slide which is substantially straight in direction.

12. An elongate Slide according to claim 8, wherein a first, adjacent and any subsequently attached sheets are arrangeable to form an elongate Slide which is not straight in direction.

13. An elongate Slide according to claim 8 comprising a plurality of sheets, wherein the opposite end of the bottom sheet of the Slide includes said means for anchorage incorporable with the underlying substrate to form anchorage of said elongate Slide.

14. An elongate Slide according to claim 8 wherein the Slide can be reconfigured into a completely rolled cylinder for carriage and fastened temporarily in this configuration.

15. A Sledge comprising a substantially oblong sheet of flexible material with means of cushioning over an underlying substrate, wherein a means of cushioning includes at least one end of said sheet, arranged to form a curved, teardrop or cylindrically configured tubular enclosure, with the tubular portion arranged substantially perpendicular to the general longitudinal axis of the sheet.

16. A Sledge according to claim 15, wherein said means for cushioning is provided at one end of a sheet only.

17. A Sledge according to claim 15, wherein said means for cushioning is provided at both ends of the sheet.

18. A Sledge according to claim 15, wherein at least one means for cushioning is permanently formed at at least one end of the sheet.

19. A Sledge according to claim 15, wherein at least one means for cushioning includes a temporary fastening means, such that said tubularly configured sheet can be released and reconfigured.

20. A Sledge according to claim 15, wherein at least one tubular portion of said Sledge includes cut out areas of the tube, forming suitable hand or footholds; positioned on the upper surface of said tubularly arranged portion of the Sledge, said hand or foothold positions being protected in use by a lower positioned part of the tubular, cushioning portion of the Sledge below.
